(19) United States
(12) Patent Application Publication
(10) Pub. No.: US 2012/0215757 A1
(43) Pub. Date: Aug. 23, 2012

(54) WEB CRAWLING USING STATIC ANALYSIS

(75) Inventors: Omri Weisman, Tel Aviv (IL); Yinnon Avraham Haviv, Beerotaim (IL); Adi Sharabani, Ramat Gan (IL); Omer Tripp, Har-Adar (IL); Marco Pistoia, Amawalk, NY (US); Takaaki Tateishi, Yamato-shi (JP); Guy Podjarny, Ottawa (CA)

(73) Assignee: INTERNATIONAL BUSINESS MACHINES CORPORATION, Armonk, NY (US)

(21) Appl. No.: 13/032,638

(22) Filed: Feb. 22, 2011

(51) Int. Cl. G06F 17/30

(52) U.S. Cl. 707/709; 707/E17.108

(57) ABSTRACT

A crawler including a document retriever configured to retrieve a first computer-based document, a link identifier configured to identify an actual string within the computer-based document as being a hyperlink-type string, and a static analyzer configured to perform static analysis of an operation on a variable within the first computer-based document to identify a possible string value of the variable as being a hyperlink-type string, where any of the strings indicate a location of at least a second computer-based document.

### FIELD

The invention relates to computer-based data retrieval and analysis in general, and more particularly to web crawling.

### BACKGROUND

Information technologists have long recognized the need to properly index computer-based documents such that the documents can be easily found by interested parties. In recent times tools and technologies have evolved to address the need to discover and index computer-based documents published and accessible through computer networks, such as the Internet or private networks.

In order to automate the discovery of computer-based documents, software tools commonly known as “crawlers” have been developed to retrieve computer-based documents, such as Hypertext Markup Language (HTML) based web pages, and navigate from computer-based document to computer-based document along hyperlinks, such as Universal Resource Locators (URLs), embedded in the documents that indicate the locations of other documents.

When a crawler retrieves a computer-based document, it typically parses the document text to identify strings that appear to be hyperlinks based on predefined character sequences, such as strings that begin with the characters “http://” or “ftp://”. The crawler then retrieves computer-based document from the locations indicated by the identified hyperlinks, parses them, and so on. In this manner crawlers gather computer-based document content for later use, such as by search engines.

One of the challenges faced by crawlers is that some hyperlinks are not embedded as strings within computer-based documents, but rather are dynamically generated by programming language instructions found within the documents. For example, hyperlinks are often generated by JavaScript™ instructions, Java™ applet instructions, and Flash™ instructions. As dynamically-generated hyperlinks are only generated when such instructions are executed, these hyperlinks cannot be identified by parsing a document's text to identify strings that appear to be hyperlinks based on predefined character sequences.

### SUMMARY

In one aspect of the invention a crawler is provided including a document retriever configured to retrieve a first computer-based document, a link identifier configured to identify an actual string within the computer-based document as being a hyperlink-type string, and a static analyzer configured to perform static analysis of an operation on a variable within the first computer-based document to identify a possible string value of the variable as being a hyperlink-type string, where any of the strings indicate a location of at least a second computer-based document.

A method and a computer program product embodying the invention are also provided.

### BRIEF DESCRIPTION OF THE DRAWINGS

The invention will be understood and appreciated more fully from the following detailed description taken in conjunction with the appended drawings in which:

FIG. 1 is a simplified conceptual illustration of a crawling system, constructed and operative in accordance with an embodiment of the invention;

FIG. 2 is a simplified flowchart illustration of an exemplary method of operation of the system of FIG. 1, operative in accordance with an embodiment of the invention;

FIG. 3 is a simplified code example useful in illustrating the invention; and

FIG. 4 is a simplified block diagram illustration of an exemplary hardware implementation of a computing system, constructed and operative in accordance with an embodiment of the invention.

### DETAILED DESCRIPTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

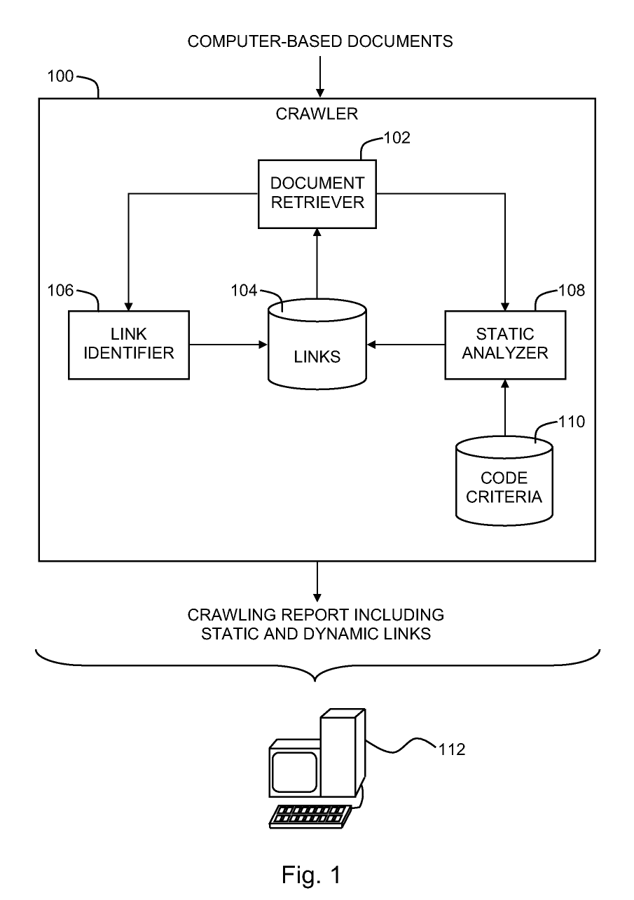

Reference is now made to FIG. 1 which is a simplified conceptual illustration of a crawling system, constructed and operative in accordance with an embodiment of the invention. In the system of FIG. 1, a crawler 100 is configured to retrieve computer-based documents, such as HTML-based web pages accessible via a computer network, and analyze retrieved documents to identify hyperlinks contained within the documents. Crawler 100 preferably includes a document retriever 102 configured to retrieve computer-based documents using conventional techniques, such as by retrieving computer-based documents at computer network locations indicated by hyperlinks, such as Universal Resource Locators (URLs), found in a repository of links 104. Crawler 100 also preferably includes a link identifier 106 configured to identify, using conventional techniques, actual strings found within retrieved documents that appear to be hyperlink-type strings, such as strings that include one or more predefined character sequences such as “http://” or “ftp://”. Hyperlinks identified by link identifier 106 are preferably stored in links 104 for later retrieval by document retriever 102.

Crawler 100 preferably includes a static analyzer 108 configured to perform data-flow static analysis on any portion of computer-based documents retrieved by document retriever 102. Static analyzer 108 preferably confines its analysis to only those portions of retrieved documents in which operations on variables are performed, such as portions written in Javascript™, Java™ applets, or Adobe™ Flash™. Static analyzer 108 may identify which portions of a document to analyze using predefined code criteria 110, such as where a portion is identified as a Javascript™ portion based on Javascript™ commands that are stored in code criteria 110. Static analyzer 108 is configured to employ conventional techniques, such as data-flow static analysis, to determine possible string values for one or more variables within an analyzed portion of a computer-based document, and identify which of the possible strings appear to be hyperlink-type strings. Hyperlinks identified by static analyzer 108 are preferably stored in links 104 for later retrieval by document retriever 102.

Crawler 100 is preferably configured to present any identified hyperlinks via a computer-controlled output medium, such as a computer display or printout.

Any of the elements shown in FIG. 1 are preferably executed by or otherwise made accessible to a computer 112, such as by implementing any of the elements in computer hardware and/or in computer software embodied in a physically-tangible, non-transient, computer-readable medium in accordance with conventional techniques.

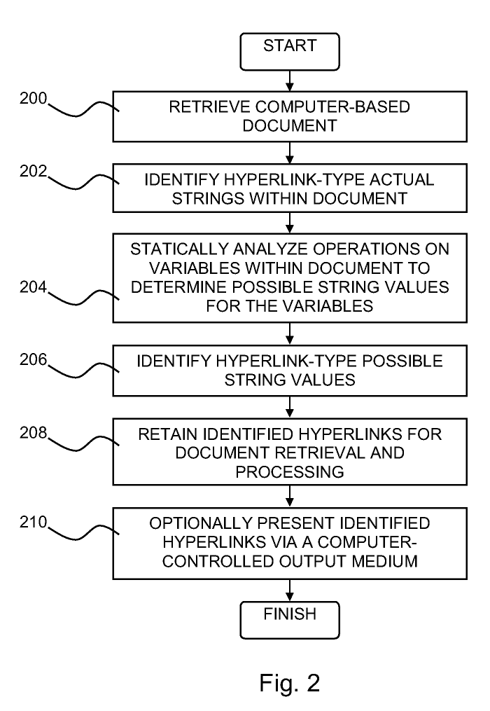

Reference is now made to FIG. 2 which is a simplified flowchart illustration of an exemplary method of operation of the system of FIG. 1, operative in accordance with an embodiment of the invention. In the method of FIG. 2, computer-based documents, such as HTML-based web pages, are retrieved, such as by retrieving computer-based documents at locations indicated by hyperlinks, such as Universal Resource Locators (URLs), found in a repository (step 200). Actual strings found within retrieved documents that appear to be hyperlink-type strings are identified in accordance with conventional techniques (step 202). Portions of retrieved documents in which operations on variables are performed are statically analyzed to determine possible string values for their variables within an analyzed portion of a computer-based document (step 204), and identify those possible strings that are hyperlink-type strings (step 206). Hyperlinks identified conventionally or by static analysis are preferably retained for retrieving and processing computer-based documents at locations indicated by the hyperlinks in accordance with the method of FIG. 2 (step 208), and may be presented via a computer-controlled output medium, such as a computer display or printout (step 210).

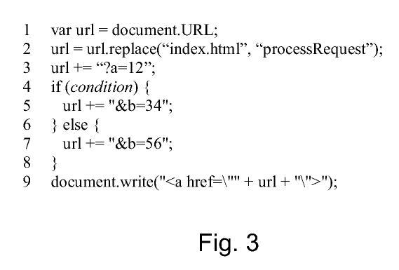

The system and method of FIGS. 1 and 2 may be illustrated with reference to FIG. 3 which shows a simplified example of JavaScript™ code that generates URLs dynamically and embeds them within an HTML-based web page that contains the JavaScript™ code. Static analysis of this code reveals the possible string values of the variable “url” that are embedded within its associated web page at line 9 of the code example. Assuming that the current URL of the web page itself is http://www.mysite.com/index.html at the time the static analysis is performed of the JavaScript™ code, the analysis yields the following information as each line of the code is processed:

| Line | Analysis Result |
|---|---|
| 1 | url = “http://www.mysite.com/index.html” |
| 2 | url = “http://www.mysite.com/processRequest” |
| 3 | url = “http://www.mysite.com/processRequest?a=12” |
| 5 | url = “http://www.mysite.com/processRequest?a=12&b=34” |
| | if the “do-if-true” branch of the conditional statement is followed |
| 7 | url = “http://www.mysite.com/processRequest?a=12&b=56” |
| | if the “do-if-false” branch of the conditional statement is followed |
| 8 | url = union of the possible values of url as discovered at lines |
| | 5 and 7, being any of the following values: |
| | “http://www.mysite.com/processRequest?a=12&b=34” |
| | “http://www.mysite.com/processRequest?a=12&b=56” |
| 9 | url = any of the following values: |
| | “http://www.mysite.com/processRequest?a=12&b=34” |
| | “http://www.mysite.com/processRequest?a=12&b=56” |

In accordance with the present invention, the various dynamically-generated URLs determined above using static analysis of the JavaScript™ code may be provided to a crawler for later retrieval. Were prior art techniques used instead to identify dynamically-generated URLs by monitoring the execution of the JavaScript™ code, only one of the URL values in the example above would be identified based on the result of the conditional statement in line 4, as either the statement at line 5 or the statement at line 7 would be executed, but not both statements, yielding only one dynamically-generated URL. As static analysis is able to consider the various possible URL values, the present invention is believed to achieve greater coverage of potential dynamically-generated URLs of retrieved web pages when compared with the prior art.

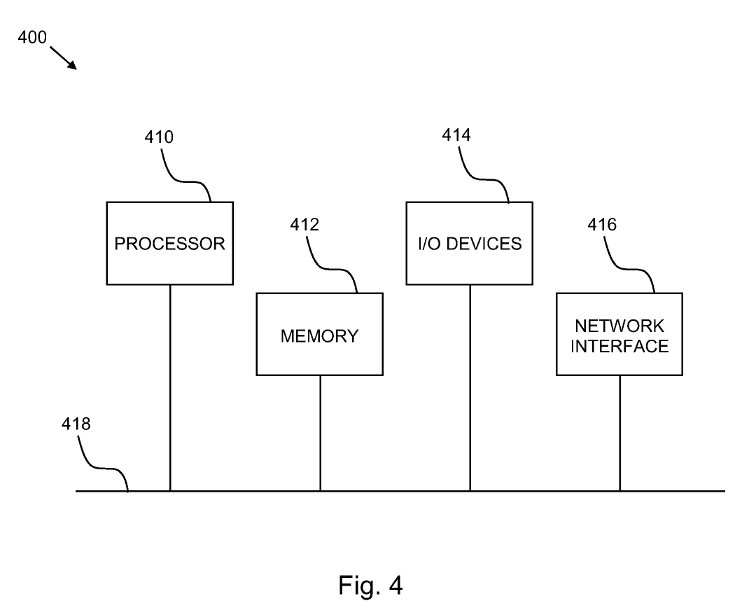

Referring now to FIG. 4, block diagram 300 illustrates an exemplary hardware implementation of a computing system in accordance with which one or more components/methodologies of the invention (e.g., components/methodologies described in the context of FIGS. 1-2) may be implemented, according to an embodiment of the invention.

As shown, the techniques for controlling access to at least one resource may be implemented in accordance with a processor 410, a memory 412, I/O devices 414, and a network interface 416, coupled via a computer bus 418 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer (not shown).

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A crawler comprising:
a document retriever configured to retrieve a first computer-based document;
a link identifier configured to identify an actual string within the computer-based document as being a hyperlink-type string; and
a static analyzer configured to perform static analysis of an operation on a variable within the first computer-based document to identify a possible string value of the variable as being a hyperlink-type string,
wherein any of the strings indicate a location of at least a second computer-based document.

2. The crawler according to claim 1 wherein the computer-based documents are as HTML-based web pages accessible via a computer network.

3. The crawler according to claim 1 wherein the static analyzer is configured to perform data-flow static analysis on the operation.

4. The crawler according to claim 1 wherein the static analyzer is configured to
identify a portion of the first computer-based document that meets predefined code criteria, and
perform static analysis on the portion.

5. The crawler according to claim 4 wherein the static analyzer is configured to confine its static analysis to only the identified portions.

6. The crawler according to claim 1 wherein the crawler is configured to present any of the strings identified as being a hyperlink-type string via a computer-controlled output medium.

7. The crawler according to claim 1 wherein any of the document retriever, link identifier, and static analyzer are implemented in any of
a) computer hardware, and
b) computer software embodied in a physically-tangible, non-transient, computer-readable medium.

8. A crawling method comprising:
retrieving a first computer-based document;
identifying an actual string within the computer-based document as being a hyperlink-type string; and
performing static analysis of an operation on a variable within the first computer-based document to identify a possible string value of the variable as being a hyperlink-type string,
wherein any of the strings indicate a location of at least a second computer-based document.

9. The method according to claim 8 wherein the retrieving, identifying, performing are performed on HTML-based web pages accessible via a computer network.

10. The method according to claim 8 wherein the performing step comprises performing data-flow static analysis on the operation.

11. The method according to claim 8 wherein the performing step comprises
identifying a portion of the first computer-based document that meets predefined code criteria, and
performing static analysis on the portion.

12. The method according to claim 11 wherein the performing step comprises performing the static analysis only on the identified portions.

13. The method according to claim 8 and further comprising presenting any of the strings identified as being a hyperlink-type string via a computer-controlled output medium.

14. The method according to claim 8 wherein the retrieving, identifying, and performing are implemented in any of
a) computer hardware, and
b) computer software embodied in a physically-tangible, non-transient, computer-readable medium.

15. A computer program product for crawling computer-based documents, the computer program product comprising:
a computer-readable storage medium; and
computer-readable program code embodied in said computer-readable storage medium, wherein said computer-readable program code is configured to
retrieve a first computer-based document,
identify an actual string within the computer-based document as being a hyperlink-type string, and
perform static analysis of an operation on a variable within the first computer-based document to identify a possible string value of the variable as being a hyperlink-type string,
wherein any of the strings indicate a location of at least a second computer-based document.

16. The computer program product according to claim 15 wherein the computer-readable program code is configured to perform said retrieving, identifying, and performing on HTML-based web pages accessible via a computer network.

17. The computer program product according to claim 15 wherein the computer-readable program code is configured to perform data-flow static analysis on the operation.

18. The computer program product according to claim 15 wherein the computer-readable program code is configured to
identify a portion of the first computer-based document that meets predefined code criteria, and
perform static analysis on the portion.

19. The computer program product according to claim 18 wherein the computer-readable program code is configured to perform the static analysis only on the identified portions.

20. The computer program product according to claim 15 wherein the computer-readable program code is configured to present any of the strings identified as being a hyperlink-type string via a computer-controlled output medium.
